(19) United States
(12) Patent Application Publication
(10) Pub. No.: US 2003/0038191 A1
(43) Pub. Date: Feb. 27, 2003

(54) Micro irrigation dropper

(76) Inventor: Jianhua Fan, Nashville, TN (US)

Correspondence Address: JIANHUA FAN, APT. C-2, 5800 MAUDINA AVE., NASHVILLE, TN, 37209-3121, US

(21) Appl. No.: 10/224,100

(22) Filed: Aug. 20, 2002

Related U.S. Application Data
(60) Provisional application No. 60/314,588, filed on Aug. 23, 2001.

(51) Int. Cl. B05B 1/00

(52) U.S. Cl. 239/597

(57) ABSTRACT

A micro irrigation dropper includes a head and a solid member, at least one groove disposed on the solid member. A snugle engage disposed on the solid member for connecting with the pipe tight enough. At least one groove being dispose on the head, or at least one notch/hole dispose on near the end of the pipe instead of the groove. The dropper can be sticked into wall of the pipe while change the shape of the head.While solid member being replaced by bristles, water flow between bristles.

This patent application claims the benefit of Provisional Application, U.S. Serial No. 60/314,588, filed Aug. 23, 2001, entitled “MICRO IRRIGATION DROPER” by Jianhua Fan.

### BACKGROUND OF THE INVENTION

1. Field of the Invention

The present invention relates to a micro drop irrigation system, more particularly to a micro irrigation dropper, the dropper placed in one end and/or side wall of a small pipe, the part of pipe where the dropper placed inserts into soil when it is in use, another end of the small pipe connect to watwer source. it is easy to use in plant field, nursery, garden, and greenhouse to reduce watering labor cost and water quantity.

2. Description of the Prior Art

The existing irrigation dropper comprising a ticker, the ticker connect to a small pipe, the ticker sits on soil in a pot while it is in use. The problems are: the ticker easily sprinkles water out side of the pot; the ticker easily drops out of the pot. If the ticker droped out of the pot, the plant in the pot will be damaged due to no enough water, so that, user must checks the tickers frequently to avoid the plants damage and water loss. It is not convenient for people to use the ticker.

It can be seen then that there is a need for “insert into soil” irrigation dropper to avoid plant damage and water loss, meanwhile save labor cost. The present invention provides a solution to solve the above and other related problems.

### SUMMARY OF THE INVENTION

The present invention relates to a dropper, more particularly to a insert into soil micro irrigation dropper to avoid plant damage, save water and labor cost.

In one embodiment of the present invention, a insert into soil micro irrigation dropper has two parts: head and solid member. The head is cone shaped for easy inserting into soil, near the solid member, the head become smaller again and having at least one groove disposed on the end to let water out. The groove is protected by the head to avoid block up by soil. The solid member which insert into the pipe having at least one groove, the groove connect to the head groove to let water out from the pipe. Also, at least one snugly engage disposed on the solid member for connecting with a pipe tight enough.

Still in one embodiment of the present invention, the end of the pipe which connect to the dropper having at least one notch, or at least one side hole near the end of the pipe instead of the groove on the head to let water out of the pipe.

In another embodiment of the present invention, the dropper having two parts: a head and bristles, the head is the same with first embodiment, the bristles replaced solid member, so that water will flow between the bristles to the groove on the head to soil, or a notch or a hole on the pipe instead of the groove on the head.

Further more, in one embodiment of the present invention, the dropper can be placed on the side wall of the pipe while change the shape of the head.

### BRIEF DESCRIPTION OF THE DRAWINGS

A better understanding of the construction and operational characteristics of a preferred embodiment can be realized from a reading of the following detailed description, especially in light of the accompanying drawings in which like reference numerals in the several views generally refer to corresponding parts.

FIG. 1 is a prospect view of a dropper with a groove on the front part of one embodiment in accordance with the principles of the present invention.

FIG. 2 is a side view of the dropper shown in FIG. 1 with a pipe.

FIG. 3 is a front view of the dropper shown in FIG. 1 with a pipe.

FIG. 4 is a left side view of the dropper shown in FIG. 1.

FIG. 5 is a right side view of the dropper shown in FIG. 1.

FIG. 6 is a prospect view of a dropper of second embodiment in accordance with the principles of the present invention.

FIG. 7 is a side view of the dropper shown in FIG. 6 with a pipe.

FIG. 8 is a front view of the dropper shown in FIG. 6 with a pipe on which a notch or a hole disposed on the wall.

FIG. 9 is a prospect view of a dropper of third embodiment in accordance with the principles of the present invention.

FIG. 10 is a side view of the dropper shown in FIG. 9.

FIG. 11 is a front view of the dropper shown in FIG. 10.

FIG. 12 is a right side view of the dropper shown in FIG. 9.

FIG. 13 is a prospect view of a dropper of forth embodiment in accordance with the principlea of the present invention.

FIG. 14 is a front side view of the dropper shown in FIG. 13.

FIG. 15 is a front view of the system including large pipe, small pipes and droppers, the large pipe conncet to water source.

FIG. 16 is a side view of droppers connceted to a pipe on the side wall of it.

### DETAILED DESCRIPTION OF THE PREFERED EMBODIMENTS

The present invention relates to a micro irrigation system, more particularly to a micro irrigation dropper.

In the following description of the exemplary embodiment, reference is made to the accompanying drawings which form a part hereof, and in which is shown by way of illustration the specific embodiments in which the invention may be practiced. It is to be understood that other embodiment may be utilized as structural changes may be made without departing from the scope of the present invention.

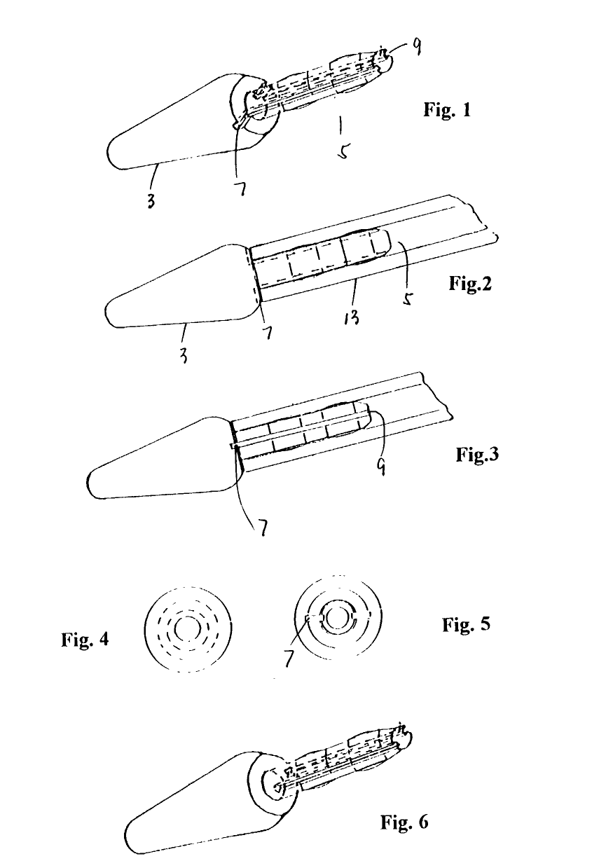

Referring now to FIG. 1, there is, generally illustrated by reference numeral 1, a micro irrigation dropper in accordance with the principles of the present invention. The micro irrigation dropper 1 includes: a head 3 and solid member 5. The solid member 5 connecting to a pipe, the solid member 5 has at least one groove 9 for water pass through it, and at least one snugly engage 11 for connecting with a pipe tight enough. The head 3 has at least one groove 7 to let water drop out which come from a pipe through the groove 9 on the solid member 5, the head 3 is a cone shaped for easy inserting into soil and avoiding soil block up the groove 7. FIG. 2 shows a side view of a dropper and a pipe in which a dropper connected to a pipe 13.

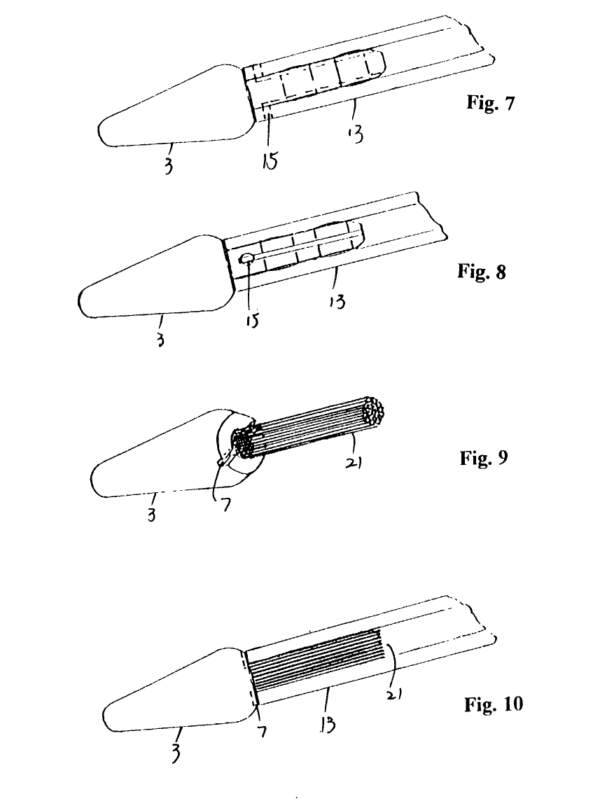

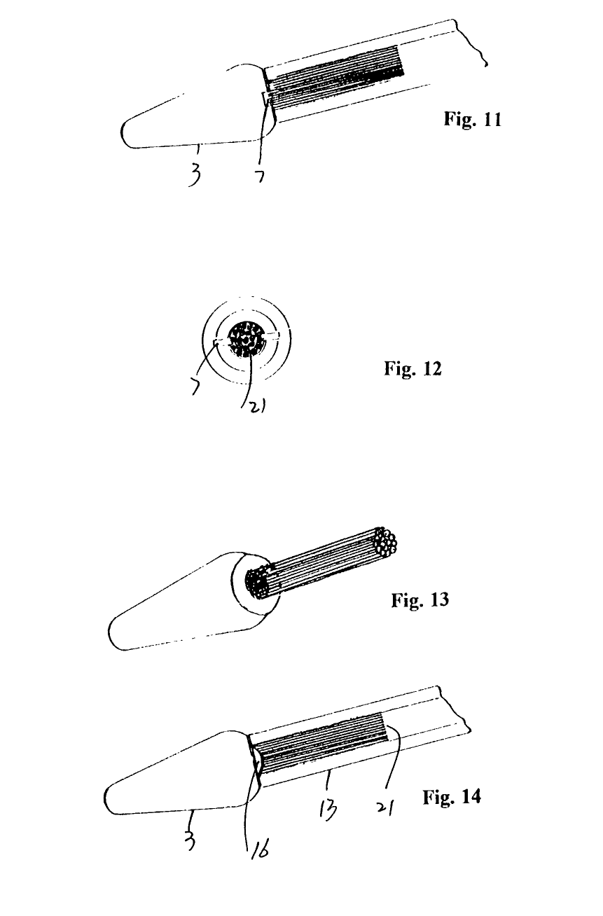

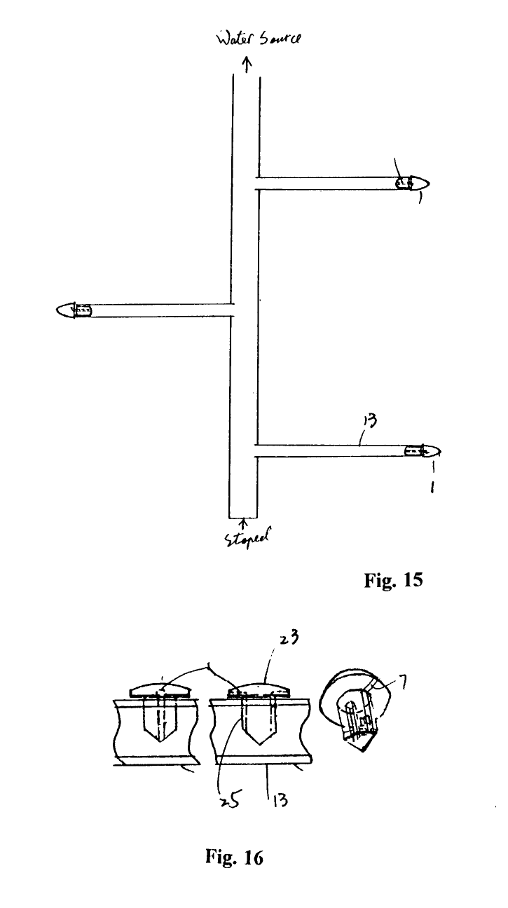

FIG. 6 shows a dropper which is the same with FIG. 1 but no groove 7 disposed on the head. FIGS. 7 and 8 show the dropper of FIG. 6 which connected to a pipe 13, at least one hole 15 or one notch 16 disposed on the wall of the pipe 13 to let water dropping out.

FIG. 9 shows the another dropper in which the solid member in FIG. 1 is replaced by bristles so that water in pipe will flow between the bristles to the groove 7. FIGS. 13 and 14 show a dropper without groove 7, but at least one hole 15 or notch 16 disposed on the wall of the pipe to let water drop out.

FIG. 16 shows another connection between a dropper 21 and a pipe 13. In this connection, the solid member 25 of the dropper 21 stick into the wall of the pipe 13. The shape of the head 23 is different with the head 3 in FIG. 1, but the structure of the groove 7 and the solid member are the same with the dropper in FIG. 1.

The foregoing description of the exemplary embodiment of the invention has been presented for the purposes of illustration and description. It is not intended to be exhaustive or to limit the invention to the precise form disclosed, many modifications and variations are possible in light of the above teaching. It is intended that the scope of the invention be limited not with detailed description, but rather by the claims appended hereto.

What is claimed is:

1. A micro irrigation dropper comprising:
a head, the head is cone shaped for easy inserting into soil and avoiding the soil block up water outlet; and
a solid member for connecting to a pipe, the solid member having at least one groove to let water pass through the solid member from pipe to the soil.

2. The micro irrigation dropper of claim 1, further comprising at least one snugly engage disposed on the solid member for connecting with a pipe tight enough.

3. The micro irrigation dropper of claim 2, wherein at least on groove disposed on the head, this groove connected with the groove which disposed on the solid member.

4. The micro irrigation dropper of claim 2, wherein at least one notch or hole disposed on the wall of the pipe near the connecting end.

5. The micro irrigation dropper of the claim 2, wherein the dropper can be sticked into the side wall of the pipe while change the shape of the head.

6. A micro irrigation dropper comprising:
a head, the head is cone shaped for easy inserting into soil and avoiding the soil block up water outlet, and
bristles, the bristles connecting to the head and a pipe, water flow between the bristles from pipe to soil.

7. The micro irrigation dropper of the claim 6, wherein the head having at least one groove to let water out which come from the bristles to soil.

8. the micro irrigation dropper of the claim 6, wherein at least one notch or hole disposed on the wall of the pipe near the connecting end.
